(19) United States
(12) Patent Application Publication
(10) Pub. No.: US 2007/0124369 A1
(43) Pub. Date: May 31, 2007

(54) Real-time interactive system for discussion on documents, images, and videos and method for the same

(76) Inventor: Chao-Hung Wu, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/287,272

(22) Filed: Nov. 28, 2005

(51) Int. Cl. G06F 15/16

(52) U.S. Cl. 709/204

(57) ABSTRACT

This invention provides the real-time interactive system for discussion on documents, images, and videos and method for the same, comprising a display screen, a telecommunication module, a handwriting module, and a controller. The handwriting module may receive handwritten tracks when sensing the inscribe movement of handwriting pen on a handwriting board. The controller shows the document, the image, and the video in an interactive area of the display screen, and in the interactive area for the document, the image, and the video as backgrounds, the discussant of the other side gets the tracks through the telecommunication module or the handwriting module. Accordingly, the operator writes on the document, image, or video to discuss with a discussant of the other side interactively through mutual video communication.

### BACKGROUND OF THE INVENTION

1. Field of the Invention

This invention to a real-time interactive system for discussion on documents, images, and videos and method for the same and particularly to a real-time interactive system for an operator to discuss with discussants on documents, images, and videos in a video conference and by means of a handwriting pen to write and method for the same.

2. Description of Related Art

Conventionally, related persons gather together to discuss on documents, images, tables and the like, and although it wastes their time to journey to and fro, they are forced to meet to discuss. The reason for this is that the details on the images, the tables and the like as documents are hardly given by telephone. For example, when an explainer ask the other party to see a numeral in a column of the table or a certain part of the image, the other party must always spend much time in communication with the explainer to figure out what the explainer explains.

Through a video telephone or a videoconference system, although the numeral on the table or the part of the image pointed out by the other party is apparent, a bandwidth of network is concerned to reduce so that the resolution is not high and the details are not very apparent. Further, if being added to the images, the tables or the like, patterns or scripts must be in advance portrayed or written with a pen and then taken with a mini-camera of the video telephone or videoconference system, so it is inconvenient for both sides to discuss on documents by using the video telephone or videoconference system.

Currently, communication over the so-called real-time AV dynamic frame is achieved to discuss with each other on the network and communicate along with dynamic operation on the screen. Although the effect on communication with each other is satisfactory, at least hundreds of Kbps (generally around 500K˜600 Kbps or even more) are required in a bandwidth for communication with each other; the reason for this is that at least 10˜20 frames per second are required for retrieval of real-time dynamic frames on a screen. Thus, it is to be achieved that both parties discuss on the network in a proper bandwidth.

### SUMMARY OF THE INVENTION

This invention is mainly to provide a real-time interactive system for discussion on documents, images, and videos and method for the same. On a document, an image, or a video, discussants of both sides use a handwriting pen as a handwriting module to write and then transmit handwritten tracks occupying a dinky bandwidth of network through a telecommunication module to each other for real-time, convenient interactive discussion.

For the object mentioned above, this invention provides the real-time interactive system for discussion on documents, images, and videos and method for the same, comprising a display screen, a telecommunication module, a handwriting module, and a controller. The handwriting module may receive handwritten tracks when sensing the inscribe movement of handwriting pen on a handwriting board. The controller shows the document, the image, and the video in an interactive area of the display screen, and in the interactive areas for the document, the image, and the video as backgrounds, the discussant of the other side gets the tracks through the telecommunication module or the handwriting module. Accordingly, the operator writes on the document, image, or video to discuss with a discussant of the other side interactively through mutual video communication.

In order to further know the features and technical means of this invention, refer to the detailed description according to this invention accompanied with drawings; however, the accompanied drawings are provided for reference and illustration only and are not limited to this invention.

### BRIEF DESCRIPTION OF THE DRAWINGS

FIG. 1 is a schematic view illustrating a real-time interactive system for discussion on documents, images, and videos of a preferred embodiment of this invention, and

FIGS. 2A to 2D are schematic views illustrating interactive discussion according to this invention.

### DETAILED DESCRIPTION OF THE PREFERRED EMBODIMENTS

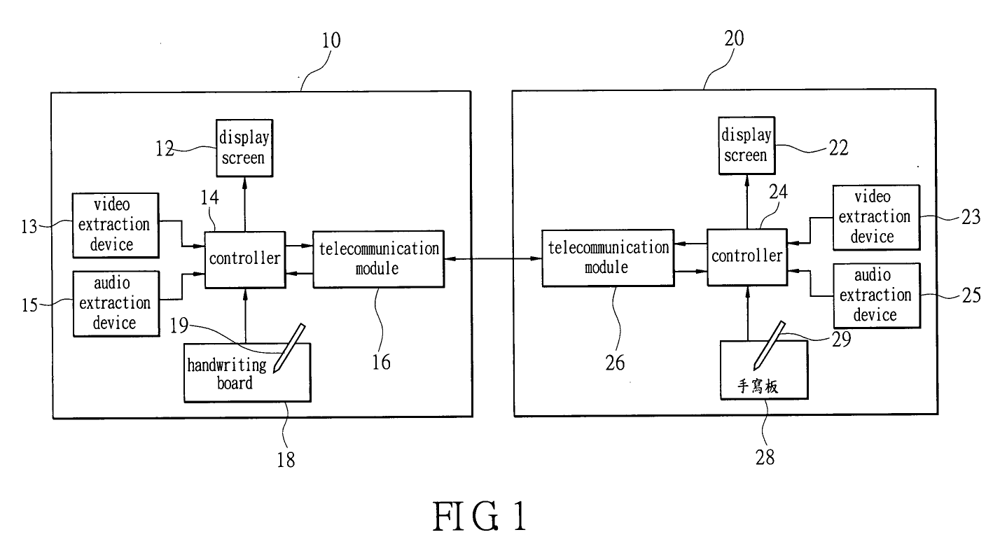

FIG. 1 is a schematic view illustrating a real-time interactive system for discussion on documents, images, and videos. As shown in FIG. 1, when interactively discussing on the network, discussants of both sides (an operator and a discussant of the other side) respectively have and use the real-time interactive system 10 and 20 for discussion on documents, images, and videos of this embodiment. In the embodiment, a display screen 12 and 22, a telecommunication module 16 and 26, a handwriting module (a handwriting pen 19 and 29, a handwriting board 18 and 28), a controller 14 and 24, a video extraction device 13 and 23, and an audio extraction device 15 and 25 are provided in the real-time interactive system 10 and 20 for discussion on documents, images, and videos.

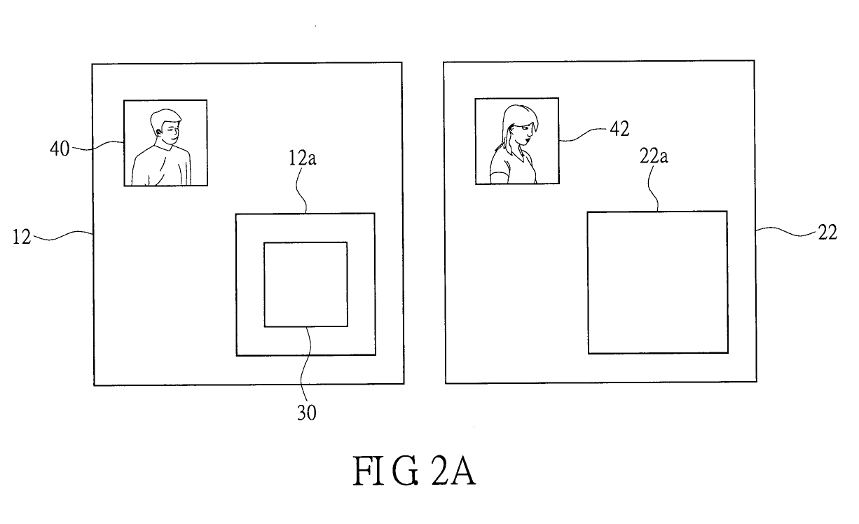

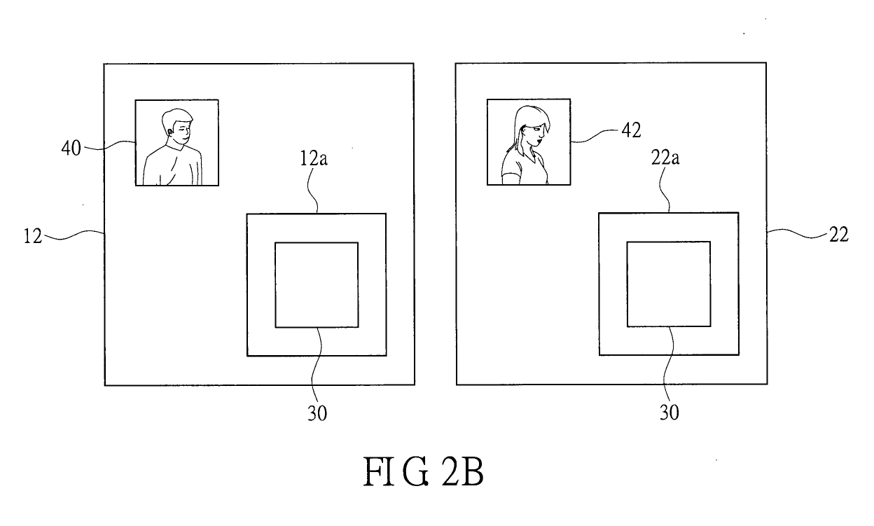

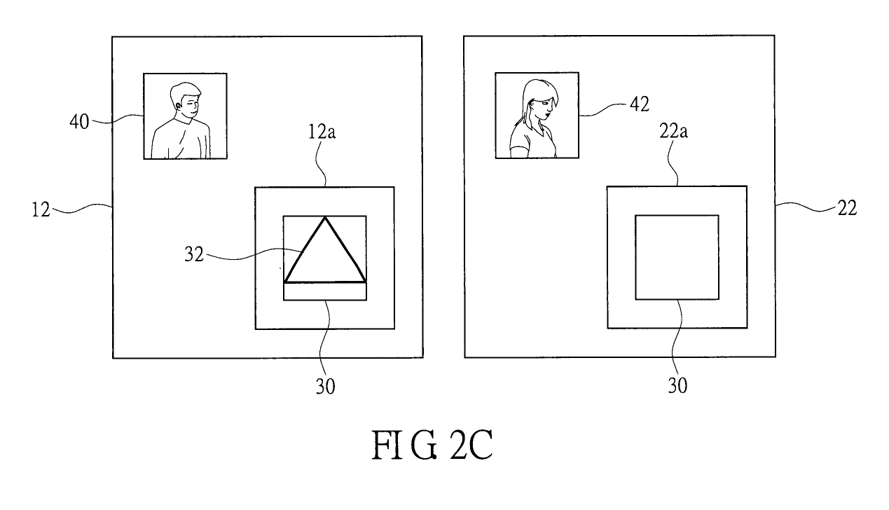

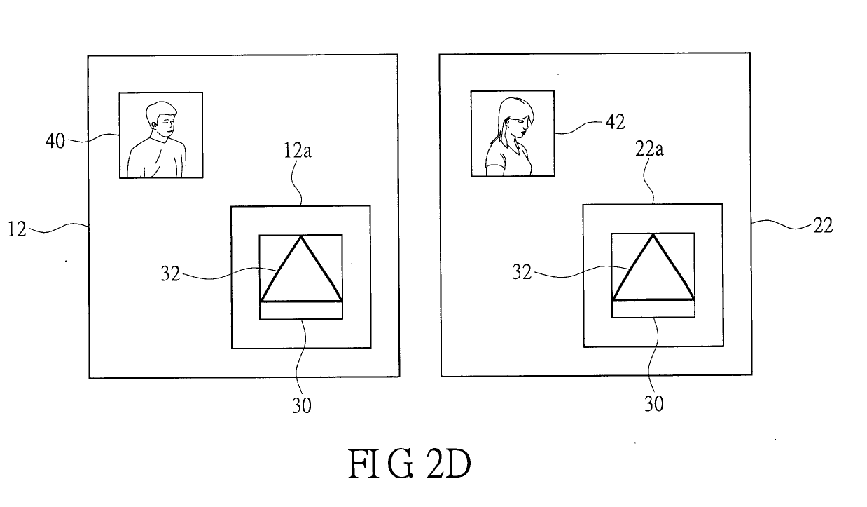

In short, when the operator having the real-time interactive system 10 wants to discuss with the discussant of the other side having the real-time interactive system 20 on the document, the image, or the video, as shown in FIG. 2A for the document, the image, or the video 30, the controller 14 may open the document, the image, or the video to be discussed and start interactive discussion on the document, the image, or the video through the handwriting track, and in the course of interactive discussion, video and/or audio may be joined to make the discussion more smooth.

In the embodiment, the operator may extract video and audio signals separately through the video extraction device 13 and the audio extraction device 15 and may write on the handwriting board 18 with the handwriting pen to get a handwriting track signal. The controller 14 may transmit the video and audio signals, the handwriting track signal, and the document, the image, or the video to the other party's real-time interactive system 20 through the telecommunication module 16, and the controller 14 attaches the handwriting track signal to the document, the image, or the video to be discussed so that the received document, image, or video and the handwriting track signal synchronously shown on the document, image, or video may be shown on the other party's display screen and the video and audio signals may be received synchronously.

In order to reduce the bandwidth of network occupied for transmission, the document, image, or video is transmitted once but not continuously, because continuous transmission consumes the bandwidth, and thus the operator and the discussant of the other side may transmit and show the handwriting track signals on the document, image, or video and join the video and audio signals for detailed explanation. Thus, depending on the handwriting track signal portrayed on the document, image, or video and the attached video and audio signals, the discussant of the other side may figure out what the operator explains. Regarding operation, the real-time interactive system 20 for discussion on documents, images, and videos owned by the discussant of the other side is the same as the operator's system 10, so detailed description is not made herein. The telecommunication module 16 and 26 may be provided to operate for network transmission.

Although the generation or handwriting track is in a conventional art, several embodiments feasible are mentioned herein. In one embodiment, an external handwriting board 18 is provided to sense the inscribe movement of handwriting pen 19 to get the handwritten track, while in the other embodiment, the handwriting board 18 is integrated together with the display screen 12 to similarly sense the inscribe movement of handwriting pen 19 to get the handwritten track, but the handwriting pen 19 writes on the display screen 12 integrated with the handwriting board 18. Alternatively, a mouse may be used to give the track when moving.

There may be two sources of the document, image, or video on which the discussants of both sides, namely two sources of the document, image, or video as the background on the screen 12, which depends on a party starting the interactive discussion. If the operator uses the real-time interactive system 10 for discussion on documents, images, and videos to start discussion, the document, image, or video may be given from the storage medium owned by the operator and may be shown on the display screen 12 and transmitted to the other party through the telecommunication module 16. If the discussant of the other side uses the real-time interactive system 20 for discussion on documents, images, and videos to start discussion, the document, image, or video is received through the telecommunication module 16 from the real-time interactive system 10 for discussion on documents, images, and videos.

Actually, before discussion, the document, image, and video got by the both parties are the same, and the controllers 14 and 24 of both sides will show the given document, image, and video on the display screens 12 and 22. Next, the operator and the discussant of the other side may on their own write on the document, image, and video by using the handwriting module (the handwriting pen 19 and 29 and the handwriting board 18 and 28) and then transmit to each other through the telecommunication module 16 and 26, thereby the both parties synchronously seeing the handwritten tracks they inscribe by themselves.

To sump, between the real-time interactive systems 10 and 20 for discussion on documents, images, and videos, on the given document, image, or video, discussants of both sides use a handwriting pen 19 and 29 as a handwriting module to write and then transmit handwritten tracks occupying a dinky bandwidth of network through a telecommunication module 16 and 26 and the video and audio signals extracted through the video extraction device 13 and 23 and the audio extraction device 15 and 25 to each other for real-time, convenient interactive discussion. More than 500 Kbps˜600 Kbps of bandwidth of network may be required to transmit the conventional dynamic AV frames, especially highest in the discussion of groups of people; however, in the system and method of this invention, the document, image, and video (non-dynamic image) and the handwritten tracks are transmitted once only, so the bandwidth of network may be reduced significantly. The video and audio signal, after properly processed, may also be controlled in the range of bandwidth of network in transmission and may be received; what is shown on the display screen 12 and 22 of the real-time interactive systems 10 and 20 for discussion on documents, images, and videos is exemplary embodiment for explaining the interactive discussion.

FIGS. 2A to 2D are schematic views illustrating interactive discussion according to this invention. As shown in FIG. 2A, the display screens 12 and 22 of the real-time interactive systems 10 and 20 for discussion on documents, images, and videos comprise an interactive area 12a and 22a and a video display area 40 and 42, respectively, in which the document, image, and video 30 are shown in the interactive area 12a of the display screen 12; however, the display screen 22 still waits to receive the document, image, and video 30, so nothing is shown in the interactive area 22a. In the video display area 40, the video signal outputted by the interactive system 20 is shown, while in the video display area 42, the video signal outputted by the interactive system 10 is shown.

After the real-time interactive system 10 for discussion on documents, images, and videos transmits the document, image, and video 30 through the telecommunication module 16 as shown in FIG. 1 to the telecommunication module 26 of the real-time interactive system 20 for discussion on documents, images, and videos, the controller 24 will show them in the interactive area 22a of display screen 22, as shown in FIG. 2B.

Next, the operator holds the handwriting pen 19 in the interactive area 12a for the document, image, and video 30 as the background, and thus the handwritten track 32 is shown in FIG. 2C; then the handwritten track 32 is shown in the interactive area 22a of display screen 22 through the telecommunication module 16 and 26, as shown in FIG. 2D.

In FIGS. 2A to 2D, in addition to the handwritten track signal used for discussion, the video and audio signals may be added, in which the video signal may be shown in the video display area 40 and 42 for achievement of the AV interactive discussion.

Besides, when the operator having the real-time interactive system 10 wants to discuss with the discussant of the other side having the real-time interactive system 20 on another document, image, and/or video, they may again discuss following the descriptions as shown in FIGS. 2A to 2D.

However, in the description mentioned above, only the preferred embodiments according to this invention are provided without limit to claims of this invention. For example, although the interactive systems are explained in detail one for one, the one-for-many operation of the systems is also rendered. All those skilled in the art without exception should include the equivalent changes and modifications as falling within the true scope and spirit of the present invention.

What is claimed is:

1. A real-time interactive system for discussion on documents, images, and videos, allowing an operator to interactively discuss with an discussant of the other side on the documents, images, and videos as background on the network and transmit them to each other, comprising:
a displaying screen;
a telecommunication module to receive and transmit the documents, images, and videos;
a handwriting module that may receive a handwritten track signal, when sensing the inscribe movement of a handwriting pen on a handwriting board;
a controller to show the documents, images, and videos in an interactive area of the display screen and show the handwritten track signal in the interactive area for the documents, images, and videos as backgrounds; and
an audio extraction device to extract an audio signal from the operator and output it from the telecommunication module through the controller.

2. The real-time interactive system for discussion on documents, images, and videos according to claim 1, wherein in the interactive systems held by the operator and the discussant of the other side, the documents, images, and videos in the interactive areas of display screens are the same.

3. The real-time interactive system for discussion on documents, images, and videos according to claim 1, wherein the documents, images, and videos may be given from a storage medium in the interactive system owned by the operator or the discussant of the other side.

4. The real-time interactive system for discussion on documents, images, and videos according to claim 1, wherein the operator and the discussant of the other side may transmit the documents, images, and videos to each other using the telecommunication module.

5. The real-time interactive system for discussion on documents, images, and videos according to claim 1, wherein the handwritten track signal is given through the handwriting module and then shown in the interactive area for the documents, images, and videos as backgrounds.

6. The real-time interactive system for discussion on documents, images, and videos according to claim 1, wherein the handwritten track signal is received through the telecommunication module and then shown in the interactive area for the documents, images, and videos as backgrounds.

7. The real-time interactive system for discussion on documents, images, and videos according to claim 1, wherein the handwritten track signal received by the handwriting module of the interactive system owned by the operator is transmitted through the telecommunication module to the interactive system owned by the discussant of the other side.

8. The real-time interactive system for discussion on documents, images, and videos according to claim 1, wherein the handwriting board in the handwriting module is integrated with the display screen.

9. The real-time interactive system for discussion on documents, images, and videos according to claim 1, further comprising:
a video extraction device to extract a video signal from the operator and output it from the telecommunication module through the controller.

10. A method for real-time interactive discussion on documents, images, and videos, allowing an operator to interactively discuss with an discussant of the other side on the documents, images, and videos as background on the network and transmit them to each other, comprising:
receiving the documents, images, and videos;
showing the documents, images, and videos in an interactive area of a display screen;
sensing the inscribe movement of a handwriting pen on a handwriting board to receive a handwritten track signal;
showing the handwritten track signal in the interactive area for the documents, images, and videos as backgrounds; and
outputting the operator's audio signal to the discussant of the other side.

11. The method for real-time interactive discussion on documents, images, and videos according to claim 10, wherein the documents, images, and videos given to the operator and the discussant of the other side are the same.

12. The method for real-time interactive discussion on documents, images, and videos according to claim 10, wherein the operator and the discussant of the other side may offer the documents, images, and videos to each other.

13. The method for real-time interactive discussion on documents, images, and videos according to claim 10, wherein the handwritten track signal may be offered when the movement of handwriting pen on the handwriting board to write is sensed and then shown in the interactive area for the documents, images, and videos as backgrounds.

14. The real-time interactive system for discussion on documents, images, and videos according to claim 10, wherein the handwritten track signal is received from the other side through a telecommunication means and then shown in the interactive area for the documents, images, and videos as backgrounds.

15. The method for real-time interactive discussion on documents, images, and videos according to claim 10, wherein the handwritten track signal received by the operator is transmitted to the discussant of the other side through a telecommunication means.

16. The method for real-time interactive discussion on documents, images, and videos according to claim 10, further comprising:
outputting the operator's video signal to the discussant of the other side.
